(19) United States
(12) Patent Application Publication
(10) Pub. No.: US 2014/0067418 A1
(43) Pub. Date: Mar. 6, 2014

(54) METHOD AND SYSTEM FOR FACILITATING COMMUNICATION BETWEEN A PATIENT AND A CARE PROVIDER

(71) Applicant: Robert C. HYZY, Ann Arbor, MI (US)

(72) Inventor: Robert C. HYZY, Ann Arbor, MI (US)

(21) Appl. No.: 13/692,102

(22) Filed: Dec. 3, 2012

Related U.S. Application Data
(60) Provisional application No. 61/713,959, filed on Oct. 15, 2012.
(60) Provisional application No. 61/695,295, filed on Aug. 31, 2012.

(51) Int. Cl. G06F 19/00

(52) U.S. Cl. CPC G06F 19/322
USPC 705/3

(57) ABSTRACT

A method for facilitating communication between a patient and a care provider is disclosed. The method includes providing a repository for storing a patient records and care provider records, wherein each care provider record includes information identifying progress notes generated by the care provider, and providing, to a first user, information identifying a first plurality of progress notes relating to a first patient and generated by a first care provider of the first patient. When an indication is received from the first user including information identifying a selected progress note of the first plurality of progress notes, a comment associated with the selected progress note, and a request to post the comment to the first care provider, a notification including the information identifying the selected progress note and the comment is transmitted to a user system associated with the first care provider.

### CLAIM OF PRIORITY

This application claims the benefit of U.S. Provisional Patent Application 61/695,295 entitled METHOD AND SYSTEM FOR FACILITATING PATIENT CARE INFORMATION BETWEEN CAREGIVERS AND PATIENTS AND/OR THEIR FAMILIES, by Robert C. Hyzy, filed Aug. 31, 2012, the entire contents of which are incorporated herein by reference. In addition, this application claims the benefit of U.S. Provisional Patent Application 61/713,959 entitled METHOD AND SYSTEM FOR FACILITATING PATIENT CARE INFORMATION BETWEEN CAREGIVERS AND PATIENTS AND/OR THEIR FAMILIES, by Robert C. Hyzy, filed Oct. 15, 2012, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to an automated process for facilitating communication between a patient and a medical care provider.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In many parts of the world, a patient and his or her family desire to be actively involved in the delivery of care when the patient is hospitalized. Indeed, when the patient and family members are more fully informed and can participate intelligently and actively in decision making, the quality of medical care may be enhanced, errors in care delivery can be reduced, and overall patient and family satisfaction can be improved.

Unfortunately, in most hospital settings, the medical care providers are often too busy to communicate at great length with the patient and/or the patient's family members, and generally cannot answer all of the patient's questions and concerns when the family members are present. Moreover, because the patient may be treated by a team of medical care providers who can change on a regular basis, the patient may encounter several different care providers without knowing who specializes in what and who is responsible for what tasks. Thus, during a hospital stay, it is not uncommon for the patient and his or her loved ones to feel detached and “left in the dark” regarding medical decision making and care.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is a block diagram illustrating an exemplary hardware device in which the subject matter may be implemented;

FIG. 2 illustrates a representative system for facilitating communication between a patient and a medical care provider according to an embodiment;

FIG. 3A and FIG. 3B are block diagrams representing exemplary systems for facilitating communication between a patient and a medical care provider according to exemplary embodiments;

FIG. 4 is an operational flow diagram illustrating a high level overview of an exemplary method for facilitating communication between a patient and a medical care provider according to an embodiment;

FIG. 5 is a block diagram representing an exemplary patient record according to an embodiment;

FIG. 6 is a block diagram representing an exemplary care provider record according to an embodiment;

FIG. 7A and FIG. 7B are block diagrams representing exemplary systems for facilitating communication between a patient and a medical care provider according to exemplary embodiments;

FIG. 8 illustrates an exemplary patient dashboard displayed on a user interface according to an embodiment;

FIG. 9A and FIG. 9B illustrate an exemplary communication page displayed on a user interface according to an embodiment;

FIG. 9C, FIG. 9D, and FIG. 9E illustrate an exemplary message thread page displayed on a user interface according to an embodiment;

FIGS. 10A-10D illustrate an exemplary care provider page displayed on a user interface according to an embodiment;

FIG. 11 illustrates an exemplary web search result page displayed on a user interface according to an embodiment;

FIG. 12 illustrates an exemplary calendar page displayed on a user interface according to an embodiment; and

FIG. 13A and FIG. 13B illustrate an exemplary composition page displayed on a user interface according to an embodiment.

### DETAILED DESCRIPTION

Methods are provided for facilitating communication between a patient and a medical care provider. According to exemplary embodiments, a medical information management (“MIM”) system includes a medical information repository that stores patient records and care provider records. In an embodiment, a patient record for a patient can include, among other things, information identifying the patient's medical care providers, and a care provider record for a medical care provider can include, among other things, information identifying the care provider's patients and information identifying progress notes relating to those patients and generated by the care provider.

According to an embodiment, the MIM system can be configured to provide, to a user, information identifying progress notes relating to the patient that are generated by a medical care provider of the patient. In an embodiment, the user can be the patient or a trusted contact of the patient. When the information is received and displayed to the user, the user can select a progress note, review it, compose a comment or question relating to the selected progress note, and provide to the MIM system an indication including information identifying the selected progress note and the comment or question.

When the MIM system receives the indication from the user, it can be configured to generate and transmit a notification to a user system associated with the medical care provider who generated the selected progress note. The notification can include, in an embodiment, the information identifying the selected progress note and the user's comment or question. When the notification is received and displayed by the care provider's user system, the care provider can respond to the user's comment, for example, by visiting the user, by calling the user, or by transmitting a response to the user via the MIM system.

In addition to transmitting a user's comment concerning a progress note to the care provider who generated the progress note, the MIM system can also be configured to help the user to understand medical terms in the progress note. In an embodiment, when a progress note includes a medical term, a link associated with information relating to the medical term can be embedded in the progress note. When the embedded link is activated, e.g., by selecting the link, the information relating to the medical term can be retrieved. For example, when the progress note is reviewed by the patient on the patient's user system and the patient selects the embedded link, the patient's user system can be configured to automatically retrieve the information relating to the medical term and to display the information to the patient.

In addition, in another embodiment, the patient record can include a contacts list of the contacts associated with the patient. Each contact can be associated with an access status that determines to what information the contact has access. According to an embodiment, in addition to providing the information identifying the progress notes to the user, the MIM system can also be configured to transmit the information to contacts on the contact list that are associated with a particular access status, and not to those that are associated with another access status. Thus, the patient's sensitive medical information can be shared with some, but not all, contacts.

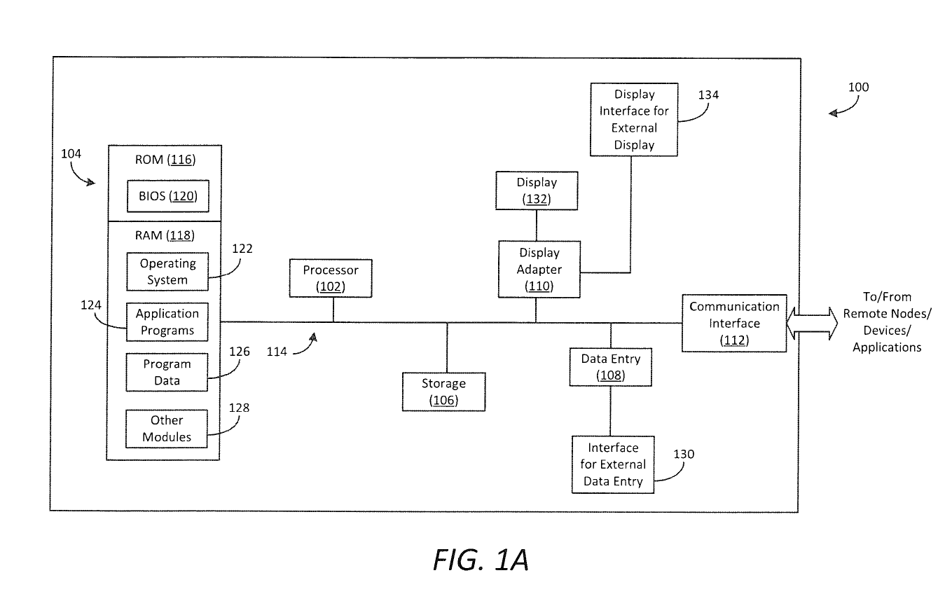

Prior to describing the subject matter in detail, an exemplary hardware device in which the subject matter may be implemented shall first be described. Those of ordinary skill in the art will appreciate that the elements illustrated in FIG. 1A may vary depending on the system implementation. With reference to FIG. 1A, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1A is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1A. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

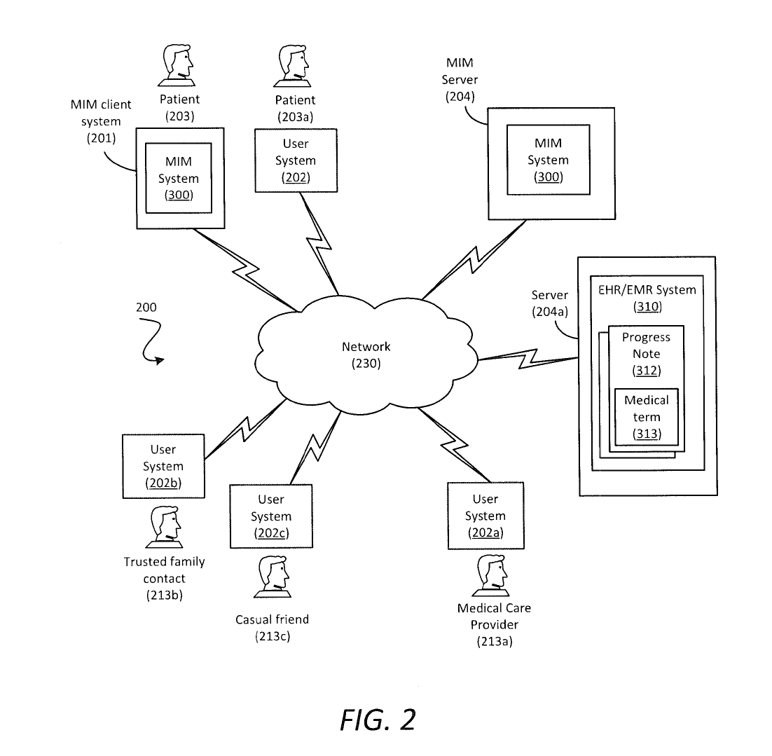

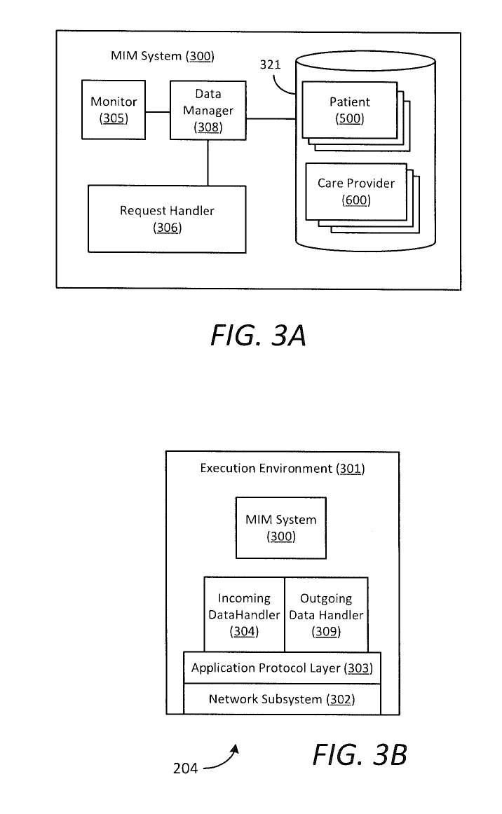

FIG. 2 and FIG. 3 illustrate representative systems 200, 300 for facilitating communication between a patient and a medical care provider according to exemplary embodiments. FIG. 2 illustrates computer system nodes 201, 202, 202a, 202b, 202c and application server computer nodes 204, 204a communicatively coupled to each other via a network 230. Exemplary system and application server computer nodes can include physical or virtual desktop computers, tablets, servers, networking devices, notebook computers, PDAs, mobile smart phones, and the like. According to an embodiment, a client system node 201 and a user system node, e.g., user system 202, can represent a virtual or physical computer device through which a user, e.g., a patient 203a, 203b, can communicate with a medical care provider 213a, and other users 213b, 213c, and with application servers 204, 204a. For example, an application server 204 can be a web server configured to transmit web content and/or webpages, and each client 201 and user 202, 202a-201c system node may include an application, such as a web portal (not shown) provided by a network browser (e.g., Chrome, Internet Explorer, Safari, etc.) or the like, that allows network communication over the network 230. The network 230 can be a local area network (LAN) or a wide area network (WAN), such as the Internet.

FIG. 3A illustrates components, and/or their analogs, that are configured to facilitate communication between a patient and a medical care provider and configured to operate within an execution environment hosted by a physical or virtual computer node and/or multiple computer nodes, as in a distributed execution environment. For example, in an embodiment, an application server node, e.g., a Medical Information Management (MIM) server node 204, can be configured to provide an execution environment 301 (shown in FIG. 3B) configured to support operation of a MIM system 300. In an embodiment, the environment 301 can include incoming 304 and outgoing 309 data handler components for receiving and transmitting information over the network 230.

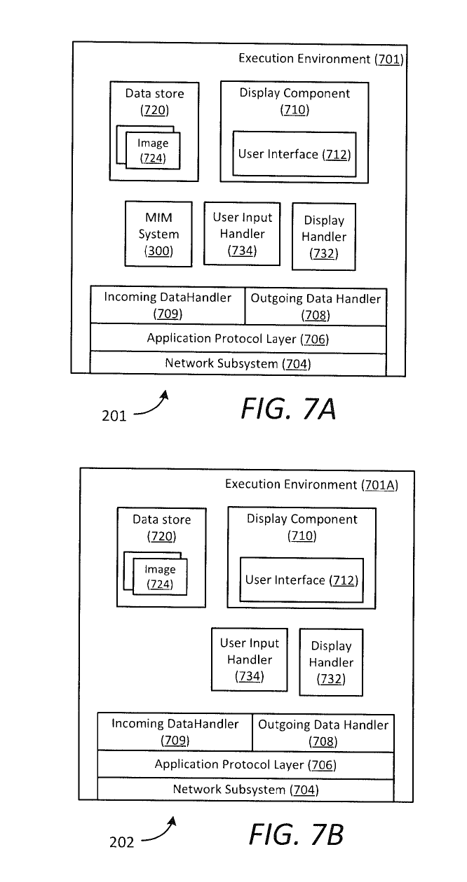

Alternatively or in addition, the MIM client system node 201 can be configured to provide an execution environment 701 (shown in FIG. 7A) configured to support operation of the MIM system 300. In an embodiment, the environment 701 can also include incoming 709 and outgoing 708 data handler components for receiving and transmitting information over the network 230. In addition, the MIM client system 201 can include a display handler component 732, and a user input handler component 734. The display handler component 732 can be configured to receive display information and to display at least a portion of the information on a user interface 712 of the user system 202. In an embodiment, the display handler component 732 can provide the information to a display component 710, which can be configured to render the information for display on the user interface 712. The user input handler component 734 can be configured, in an embodiment, to receive input information from the patient 203. The input information can be received in a number of ways. For example, it can be received via explicit input by the patient 203 using an input device such as a keyboard or touch screen, via audio input, and/or via a scanning or imaging device.

According to an embodiment, the execution environments 301, 701 or an analog, provided by the MIM server node 204 and the MIM client system node 201 respectively can access an electronic health records (EHR) and/or electronic medical records (EMR) system 310 hosted in another application server 204a coupled to the network 230. The EHR/EMR system 310 can be configured to manage electronic health/medical records associated with patients. The health/medical records can include, but is not limited to, patient histories, progress notes 312, medications, and test results. The EHR/EMR system 310 can be a proprietary system or a commercially available system, such as that provided by Epic Systems Corporation of Verona, Wis., USA.

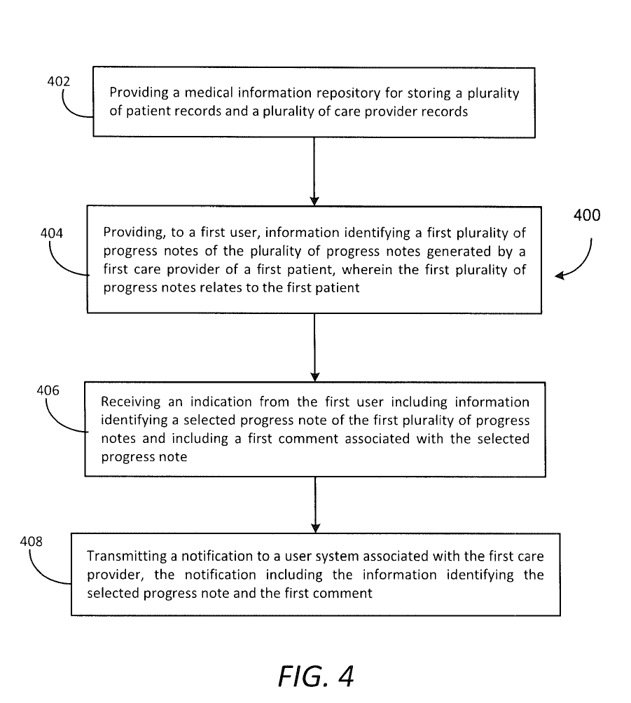

Referring now to FIG. 4, a flow diagram is presented illustrating a method 400 for facilitating communication between a patient and a medical care provider according to an embodiment. In an embodiment, the exemplary system illustrated in FIG. 3 includes an arrangement of components configured to implement the method 400, which also can be carried out in environments other than that illustrated in FIG. 3. According to an embodiment, the method 400 begins, in block 402, by providing a medical information repository for storing a plurality of patient records and a plurality of care provider records.

In an embodiment, the MIM system 300 includes a medical information repository 321 for storing at least one of a plurality of patient 500 and at least one of a plurality of care provider 600 records. In an embodiment, the repository 321 can be a database system located in a cloud computing environment, and/or may be a database system in the secure MIM server 204 controlled by a medical facility. Alternatively or in addition, the repository 321 can be a local storage component in the MIM client device 201. The MIM system 300 can include a data manager component 308 that can be configured to insert, delete, and/or update the records 500, 600. In addition, the MIM system 300 can include a monitoring agent 305 that is configured to monitor updates to the medical records managed by the EHR/EMR system 310 that are related to the records 500, 600 stored in the repository 321. For example, the monitoring agent 305 can be configured to detect when a patient is released from the hospital, or when a new progress note is generated. In response, the monitoring agent 305 can be configured to direct the data manager component 308 to update or generate corresponding records 500, 600 accordingly.

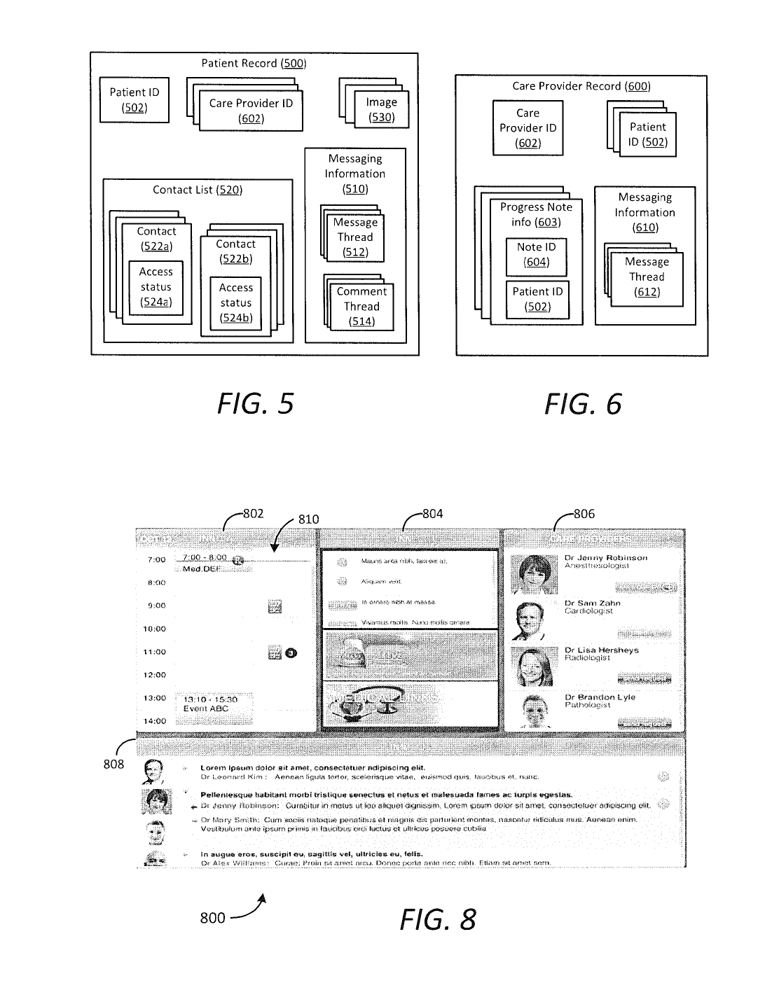

FIG. 5 is a block diagram illustrating an exemplary patient record 500 for a patient 203 and FIG. 6 is a block diagram illustrating an exemplary care provider record 600 for a medical care provider 213a according to an embodiment. Each patient record 500 can include, in an embodiment, information identifying the patient 203, information identifying at least one care provider of the patient, and messaging information 510 of the patient 203. For example, the patient record 500 can include a patient identifier (ID) 502, and care provider IDs 602. In a similar manner, each care provider record 600 can include information identifying a care provider 213a, information identifying the care provider's patients, information relating to each of a plurality of progress notes generated by the care provider 603, and messaging information of the care provider 610. For example, the care provider record 600 can include a care provider ID 602, patient IDs 502, and progress note information 603 of a progress note for a patient 203 can include a progress note ID 604 and a patient ID 502 associated with the patient 203.

According to an embodiment, the MIM client system 201 can be provided to a patient 203 when, for example, the patient 203 is admitted into a medical care facility or when the patient is receiving medical treatment, e.g., at a medical clinic or office. In another embodiment, a standard user system 202, such as a network enabled tablet computer or other handheld computer device, can be provided to another patient 203a, which, in an embodiment, can be configured to provide an execution environment 701a (shown in FIG. 7B) configured to support components, and/or their analogs, for displaying information, and receiving and transmitting information from and to the MIM server 204 over the network 230. For example, according to an embodiment, the patient's user system 202 can include most of the components operating in the MIM client system 201 except for the MIM system 300. For example, as shown in FIG. 7B, the user system 202 can include incoming 709 and outgoing 708 data handler components, a display handler component 732, a display component 710 and a user interface 712, and a user input handler component 734, where similar numbering denotes similar components.

According to an embodiment, the MIM system 300 can be invoked when a triggering event is detected. For example, the triggering event for the MIM client system 201 can be the powering up of the client system 201. Whereas, the triggering event for the user system 202 can be accessing a home webpage from the MIM server 204. In another embodiment, the triggering event can be based on a specified time and/or a specified time period. According to an embodiment, when the MIM system 300 is invoked, the patient 203, 203a can register with or log into the MIM system 300. For example, the MIM system 300 can be configured to provide and the client system 201 and the user system 202 can be configured to display to the patient 203, 203a a registration/login page via the user interface 712.

When the patient's registration and/or login information is received by the user input handler component 734, the information and a request to register or login can be transmitted to the MIM system 300 in the server 204 or routed directly to the MIM system 300 in the client system 201. For example, in an embodiment, the input handler component 734 can be configured to provide the registration/login information and the request to register/login to the outgoing data handler 708, which can be configured to generate a message that includes the information and the request. The outgoing data handler 708 can interoperate directly with a protocol layer of a network subsystem 704 or with an application protocol layer 706, such as an HTTP protocol layer, to transmit the message as a whole or in parts to the MIM server 204 hosting MIM system 300 over the network 230.

According to an embodiment, the MIM server 204 can be configured to receive the message from the patient's user system 202 over the network 230 via a network subsystem 302 and an application protocol layer 303, or other higher protocol layer such as an HTTP protocol layer among many possible standard and proprietary protocol layers. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP). A request handler component 306 in the MIM system 300 can be configured to receive the information in the message via the incoming data handler 304 for further processing.

According to an embodiment, when the patient 203, 203a is registering, the MIM system 300 can be configured to create a patient record 500 for the patient 203 and to generate the patient ID 502 associated with the patient 203. In an embodiment, the MIM system 300 can also be configured to determine the patient's care provider(s) and to include information identifying them, e.g., care provider IDs 602, in the patient record 500. For example, in an embodiment, the patient's care provider 213a can be determined based on information contained in the EHR/EMR system 310. Alternatively or in addition, the MIM system 300 can be configured to receive information relating the patient's care provider 213a, e.g., the provider's contact information, directly from the patient 203. For example, in response to receiving the request to register, the MIM system 300 can provide to the patient 203, 203a a request to provide the information relating to at least one care provider 213a, e.g., the patient's primary care provider, and when that information is received, the MIM system 300 can include it in the patient record 500 associated with the patient 203.

In addition to the patient ID 502 and the care provider ID(s) 602, the patient record 500 can also include a contacts list 520 that includes information relating a plurality of contacts 522b, 522c associated with the patient, e.g., 203. For example, the patient's contacts can include a trusted family member 213b and a friend 213c, and the information relating to those contacts 213b, 213c can include their names, email addresses, and/or mobile phone numbers. In an embodiment, each contact 213b, 213c, can be associated with an access status that indicates the relationship between the contact 213b, 213c and the patient 203. For instance, a first access status 524a can identify a contact as a trusted party, e.g., a trusted family member 213b, and a second access status 524b can identify a contact as a friend 213c.

According to an embodiment, the access status determines a degree to which the contact 213b, 213c has access to the medical information included in the patient's patient record 500 and can utilize all of the services available to the patient 203. For example, a trusted contact 203b that is identified as a trusted party and that is associated with the first access status 524a can have full access to the medical information included in the patient's patient record 500 and can utilize all of the services available to the patient 203. In this case, the trusted contact's 203b access rights and privileges are equivalent to those of the patient 203. Accordingly, unless otherwise noted, the information and services available to the patient 203 apply equally to the information and services available to the trusted contact 203b. Conversely, a casual contact 203c that is identified as a friend 203c and that is associated with the second access status 524b can have no access to the medical information and can utilize only a limited portion of the services. Although first and second access statuses have been described, many other access statuses can be defined that allow the patient 203 to define varying degrees of access and privileges. For example, another access status can be defined that gives the associated contact full access to the medical information included in the patient's patient record 500, but does not permit the contact to submit questions to the care providers 213a.

In an embodiment, the patient 203, 203a can add or remove a contact from the contacts list 520. For example, when the trusted contact 203b is added to the list 250, the MIM system 300 can be configured to receive information relating to the trusted contact 203b and the contact's access status 524a, and can be configured to add contact information 522a of the contact 203b to the contacts list 520 in the patient record 500 associated with the patient 203. When the new contact information 522a is added to the contacts list 520, a message including an invitation to register with the MIM system 300 can be transmitted to a user system 202b associated with the new contact 213b. When registration information relating to the new contact 203b is received from the contact's user system 202b, the MIM system 300 can be configured to register the trusted contact 213b.

In an embodiment, the patient record 500 can include additional information relating to the patient 203, 203a. For example, the patient record 500 can include, but is not limited to, at least one of calendaring information, a history of websites visited by the patient, a list of web searches performed by the patient, and information identifying the patient's prescribed medications. The calendaring information can include the patient's scheduled treatments, office visits, and other appointments and/or milestones, and also can include when certain medications should be administered. Once created, the patient record 500 can be stored in the medical information repository 321.

According to an embodiment, when the patient 203, 203a logs into the MIM system 300 and/or completes the registration process, the MIM system 300 can be configured to provide patient dashboard information including at least some of the information included in the patient's patient record 500 for display to the patient 203, 203a by the client 201 or the user 202 system. In an embodiment, the display handler component 732 in the MIM client system 201 can be configured to receive the dashboard information directly from the MIM system 300. Alternatively, the display handler component 732 in the user system 202 can receive the dashboard information via the incoming data handler 709. In either case, the information can be provided to the display component 710, which can be configured to render the dashboard information for display on the user interface 712.

FIG. 8 illustrates a user interface displaying an exemplary patient dashboard 800. In an embodiment, the dashboard 800 can include a calendar window 802, a web search window 804, a care provider window 806, and a communications window 808. In an embodiment, the calendar window 802 can include a 24 hour calendar of events that provides a list of scheduled daily activities, such as physical therapy, radiology, and/or surgery, as well as a list of scheduled medications by time. In addition, the calendar window 802 can include a journal section 810 that indicates when the patient 203 has posted a journal entry and whether responses have been received. The web search window 804 can list the most recent web searches, and selected searches can be locked in place so that they do not sunset upon the performance of additional searches.

The care provider window 806 can include a list of medical care providers 213a who are involved in the delivery of health care services to the patient, e.g., 203. For each care provider 213a, the care provider window 806 can indicate the care provider's communication status. For example, the provider's communication status can be active when the provider has agreed to participate in communications with the patient 203, can be pending when the provider has been asked to participate and a response has not been received yet, or can be inactive when the provider has not yet been asked to participate. The communication window 808 can include a list of comments and/or questions from the patient 203 and/or the trusted contact 213b to the patient's care providers 213a. For each comment, the window 808 can also include a response from a care provider 213a and can include an indication to alert the patient 203 that a new response has been received.

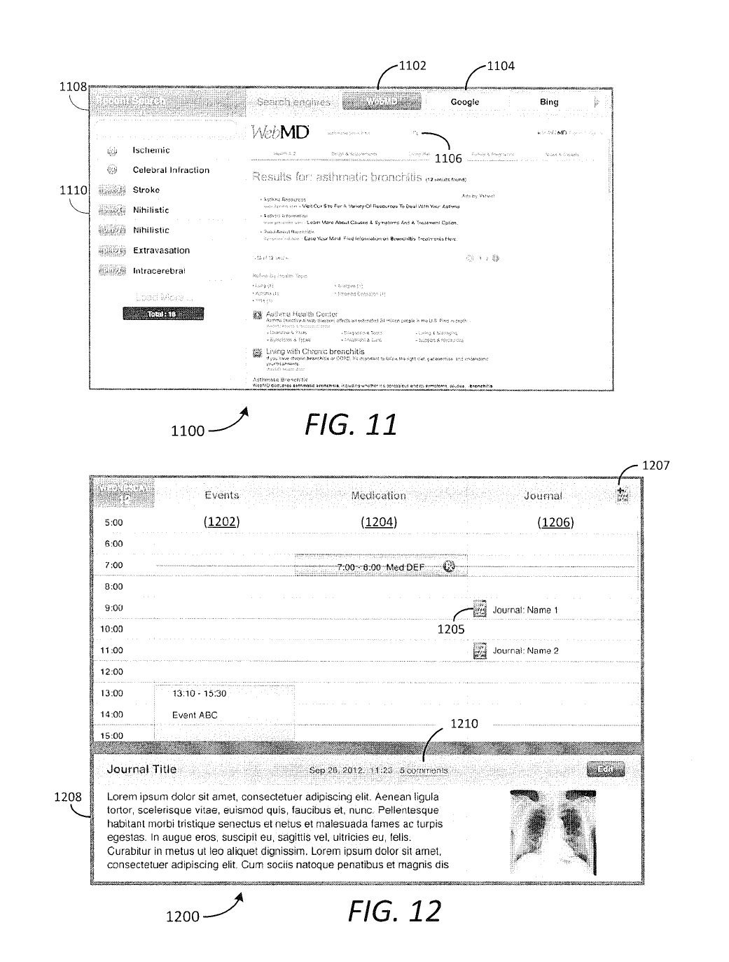

According to an embodiment, when any of the windows 802, 804, 806, 808 is selected, more detailed information and additional functionality relating to the respective topics can be provided to the patient 203/trusted contact 213b. For example, when the web search window 804 is selected, a search page 1100 such as that shown in FIG. 11 can be provided by the user interface 712. In an embodiment, the patient 203 can use the search page 1100 to perform web searches using medical web portals 1102 and/or general web based search engines 1104. A new web search can be initiated by entering a search term in a search window 1106, while recent search terms can be listed in reverse chronological order in a search history section 1108. In an embodiment, the patient 203 can pin a search term 1110 in the history section 1108 so that it does not sunset from the section 1108.

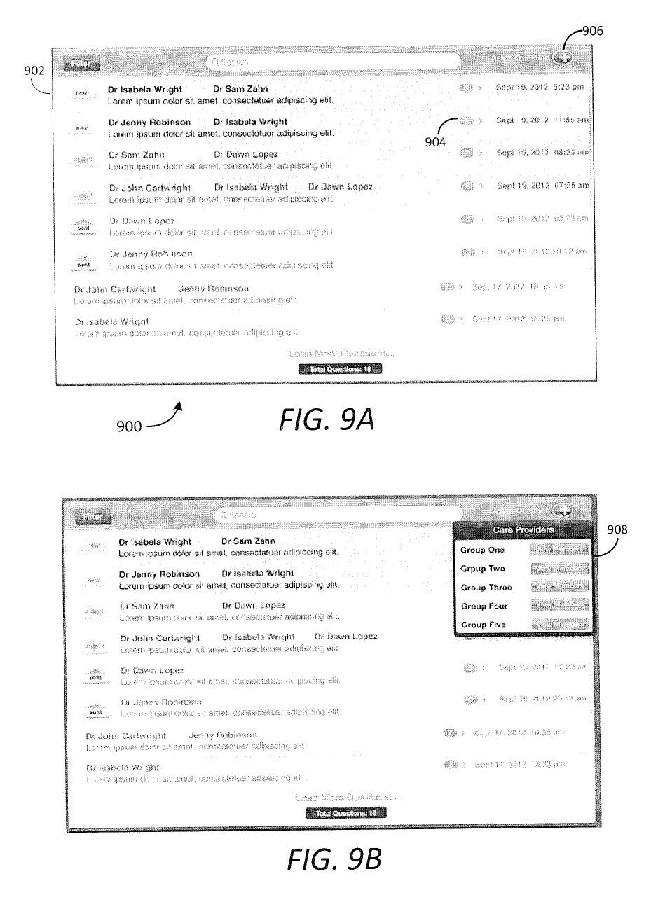

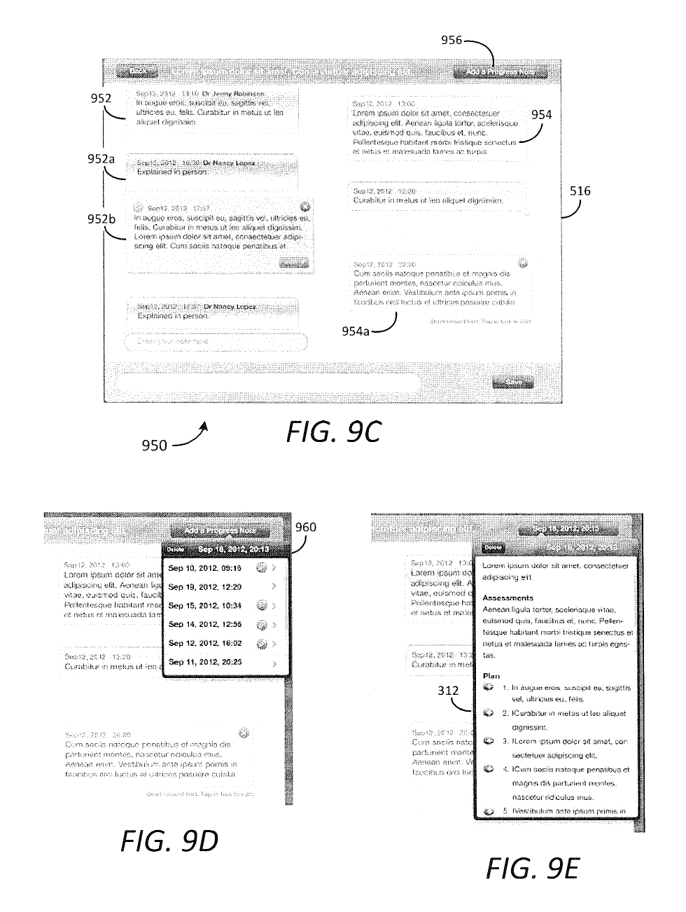

According to an embodiment, when the communications window 808 is selected, more detailed information relating to communications between the patient 203 and care providers 213a associated with the patient 203 can be displayed in a communication page 900 as shown in FIG. 9A. In an embodiment, each row 902 can represent a comment or question which has been created by the patient 203/trusted contact 213b for submission to at least one care provider 213a. The questions can be ordered alphabetically by care provider 213a, and/or grouped with the comments/questions for which a new reply has been received at the top, followed by unsent comments/questions, sent comments/questions, and inactive comments/questions. Moreover, the comments/questions displayed can be filtered by any attribute of a comment including comments having a new reply, unsent comments, sent comments, inactive comments, and/or archived comments. In an embodiment when an original comment/question has multiple responses and/or follow up comments, each row 902 can indicate the number of responses and/or follow up comments/questions 904 for the original comment/question.

According to an embodiment, the patient 203 or a trusted contact 213b can create a new comment or question by selecting an “Ask a Question” button 906 provided in the communication page 900. Care providers 213a can be grouped by service, as is shown in FIG. 9B, in order to accommodate an approach adopted by many teaching hospitals. In an embodiment, when the Ask a Question button 906 is selected, a drop down menu 908 of the service groups can be displayed, and the patient 203 can select to which group the new comment/question can be directed.

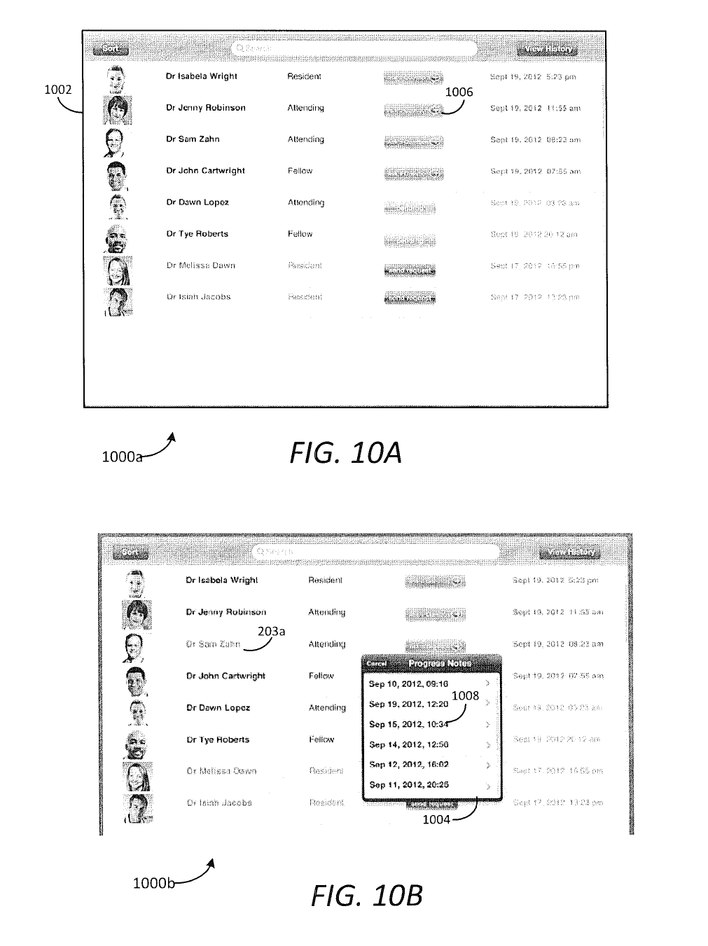

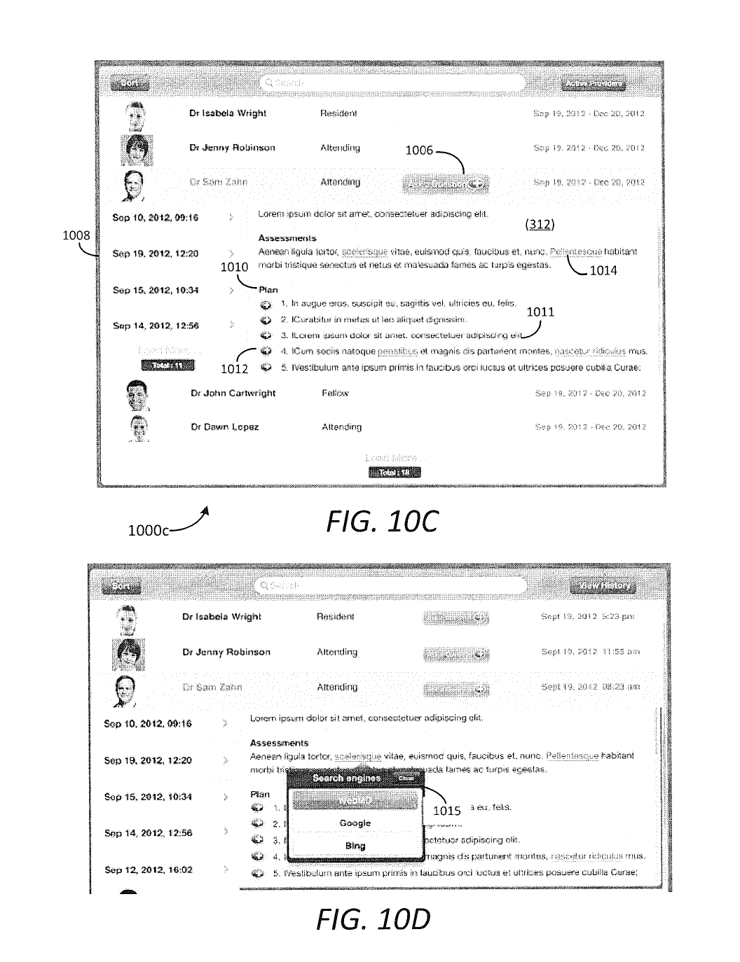

Alternatively, or in addition, when the care provider window 806 is selected, more detailed information relating to the patient's care providers 213a can be displayed in a page 1000a as shown in FIG. 10A. In an embodiment, each row 1002 can represent a care provider 213a and can include information identifying the care provider, e.g., name and title, and the care provider's communication status. The care providers 213a can be sorted any criteria, such as alphabetically by name, by communication status, and/or by date of most recent communication. According to an embodiment, when the care provider's communication status is “active,” the row 1002 corresponding to the care provider 203a can include an “Ask a Question” button 1006, which when selected, allows the patient 203 or trusted contact 213b to create a comment or question directed to the selected care provider 213a.

According to an embodiment, when the care provider 213a or the service group is selected, e.g., via the communication page 900 or the care provider page 1000, a request to communicate with the selected care provider 213a can be provided to the MIM system 300. For example, when the patient 203 is using the MIM client system 201, the user input handler component 734 can be configured to receive an indication selecting the care provider 213a and including information identifying the patient 203, information identifying the selected care provider 213a and a request to communicate. The information identifying the patient 203 can be, for example, the patient ID 502 associated with the patient 203 and the information identifying the selected care provider can be the care provider ID 602. In an embodiment, the indication can be routed directly to the MIM system 300.

Alternatively, when a trusted contact 213b is using a user system 202b, the request to communicate with the selected care provider 213a can be transmitted from the user system 202b, to the MIM system 300 hosted by the MIM server 204 via the network 230. In this case, the user input handler component 734 of the contact's user system 202b can be configured to receive an indication selecting the care provider 213a and to generate a message including information identifying the patient 203, information identifying the selected care provider 213a and a request to communicate. In an embodiment, the message can be provided to the outgoing data handler 708, which can be configured to transmit the message, as a whole or in parts, to the MIM server 204 hosting MIM system 300.

In an embodiment, when the request to communicate is received by the MIM system 300, the request handler component 306 can be configured to extract the patient ID 502 and the provider ID 602 from the indication or message, and to use the patient ID 602 to identify the care provider record 600 associated with the selected care provider 213a via the data manager component 308. As stated above, the care provider record 600 can include progress note information 603 for each of a plurality of progress notes 312 generated by the care provider 213a. In an embodiment, the request handler component 306 can be configured to use the patient ID 502 to identify a first plurality of progress notes generated by the care provider 213a and relating to the patient 203. For example, the request handler component 306 can identify the related progress notes when the patient ID 502 matches the patient ID 502 in the progress note information 603.

Referring again to FIG. 4, in response to receiving the request to communicate with the care provider 213a, information identifying the first plurality of progress notes generated by the care provider 213a and relating to the patient 203 is provided to the requesting user, e.g., the patient 203 or the trusted contact 213b, in block 404. According to an embodiment, the information identifying the first plurality of progress notes can include the progress note ID 604 of each progress note. The progress note ID 604 can include, in an embodiment, a timestamp corresponding to the date and time when the progress note was generated.

In an embodiment, the outgoing data handler 309 of the MIM server 204 can be configured to transmit the information identifying the first plurality of progress notes to the trusted contact's user system 202b via the network subsystem 302 and the network 230. Note that because the casual contact 203c is not entitled access to the patient's medical information, the outgoing data handler 309 can be configured not to transmit the information identifying the first plurality of progress notes to the casual contact's user system 202c.

In an embodiment, when the information identifying the first plurality of progress notes is identified by the request handler 306, and optionally received by the user system 202b, the information can be routed to the display handler component 732, which can be configured to render the information for display on the user interface 712 as shown in FIG. 10B. In this exemplary page 1000b, in response to selecting the “Ask a Question” button 1006 corresponding to the care provider 213a, the timestamps 1008 of the first plurality of progress notes can be displayed in a window 1004. According to an embodiment, the patient 203 or trusted contact 213b can view a progress note by selecting a timestamp 1008 corresponding to the progress note. For example, when the timestamp 1008 is selected, a request to view the progress note can be routed to the MIM system 300 in the client system 201 or transmitted from the user system 202b to the MIM server 204 via the network 230.

In an embodiment, when the request to view is received by the MIM system 300, the request handler component 306 can be configured to retrieve the requested progress note 312 generated by the care provider 213a and relating to the patient 203 from the EHR/EMR system 310. According to an embodiment, when the progress note 312 includes a medical term 313 that may be unfamiliar to the patient 203 or trusted contact 213b, the request handler component 306 can be configured to embed a link for the medical term 313 in the progress note 312 that is associated with a definition of the medical term. In an embodiment, the embedded link can be a hyperlink associated with a web search engine, which when activated, can cause a search request to be transmitted to the web search engine for information relating to the medical term.

According to an embodiment, the requested progress note 312 is retrieved by the MIM system 300 in the client system 201, or retrieved and included in a response message generated by the outgoing data handler 309 and transmitted to the user system 202b over the network 230. In an embodiment, when received or received, the requested progress note 312 can be routed to the display handler component 732, which can be configured to render the note for display on the user interface 712 as shown in FIG. 10C. In an embodiment, an embedded link 1014 for a medical term 313 can be represented as shown. In an embodiment, the patient 203 can select the link 1014 and a list of search engines can be provided in a popup window 1015, as shown in FIG. 10D. When one of the search engines is selected, a search query including the medical term 313 can be transmitted to the web search engine, and information relating to the medical term can be retrieved and displayed to the patient 203 as shown in FIG. 11.

According to an embodiment, when the patient 203 or trusted contact 213b is ready, a comment or question relating to the progress note 312 can be writeen. In an embodiment, each progress note 312 can include a plan list 1010, as shown in FIG. 10C, that identifies at least one issue or problem. The patient 203 or trusted contact 213b can write a comment or question relating to an issue or problem 1011 in the plan list 1010 by selecting an icon 1012 associated with the problem. Alternatively, or in addition, the comment or question can be related to the progress note 312 in general by selecting the “Ask a Question” button 1006. When the icon 1012 or the button 1006 is selected, the patient 203 or trusted contact 213b can write and submit the comment or question in a text box (not shown).

In an embodiment, the input handler component 734 can be configured to receive the written comment and to associate the comment with the selected problem 1011 or the progress note 312 in general. The input handler component 734 can be configured to generate an indication that includes at least one of information identifying the patient 203, information identifying the care provider 213a, information identifying the progress note 312, e.g., the note ID 604, and/or information identifying the selected problem 1011 in the progress note 312, and the written comment, and a request to post the comment to the identified care provider 213a. The indication can then be routed to the MIM system 300 in the client system 201 or transmitted in a message from the user system 202b to the MIM server 204 via the network 230.

Referring again to FIG. 4, in block 406, the MIM system 300 is configured to receive the indication that includes the information identifying the selected progress note 312 of the first plurality of progress notes and including the comment associated with the selected progress note 312. According to an embodiment, when the indication is received, the request handler component 306 in the MIM system 300 can be configured to determine whether the patient 203 is permitted to post the comment to the care provider 213a.

For instance, as mentioned above, the care provider's communication status indicates whether the care provider 213a agrees to participate in communications with the patient 203. When the care provider's communication status is active, i.e., the care provider 213a has accepted an invitation to communicate with the patient 203 and/or the trusted contact 213b, the patient is permitted to post the comment to the care provider 213a. Otherwise, the patient 203 is not permitted to post comments to the care provider 213a. In an embodiment, the care provider's communication status relating to the patient 203 can be stored in the patient's patient record 500 along with the care provider ID 602 and/or in the care provider record 600 along with the patient ID 502. Accordingly, the request handler 306 can determine whether the patient 203 or trusted contact 213b is permitted to post based on the patient 500 and/or care provider 600 record.

Alternatively or in addition, in an embodiment, the number of comments that the patient 203 is permitted to post to the care provider 213a can be limited by a threshold value, and when the number of comments does not exceed that value, the request handler component 306 can determine that the patient 203 is permitted to post the comment to the care provider 213a. For example, in an embodiment, the care provider 213a can be allowed to determine, for each of the care provider's patients, the number of comments or questions the patient 203 and/or trusted contact 213b can post to him or her within a predetermined time period, e.g., within an hour, day, or week. The care provider 213a can also limit the number of follow up questions related to an initial comment or question. The threshold value can be stored in the patient's patient record 500 along with the care provider ID 602 and/or in the care provider record 600 along with the patient ID 502.

In an embodiment, when the request handler 306 determines that the patient 203 or trusted contact 213b is not permitted to post the comment to the care provider 213a, a response including an error message can be provided to the patient 203 or transmitted to the trusted contact's user system 202b. The error message can include a statement explaining a reason why the request to post was denied. Alternatively, when the request handler 306 determines that the patient 203 or trusted contact 213b is permitted to post the comment to the care provider 213a, a notification including the information identifying the selected progress note 312 and the comment can be generated and transmitted, in block 408, to a user system 202a associated with the care provider 203a. According to an embodiment, the notification can be pushed to the care provider's user system 202a so that the care provider 203a receives the notification immediately. Alternatively or in addition, the notification can be pulled from the MIM client 201 or the MIM server 204 in response to a request for notifications from the care provider's user system 202a.

According to an embodiment, in addition to generating the notification, the comment and the information identifying the progress note 312 can be copied and stored in the patient's patient record 500 and/or the care provider's record 600. For example, in an embodiment, when the comment is an originating comment, i.e., it is not a response to another comment or question, a message thread 512, 612 can be generated and the originating comment along with the information identifying the progress note 312 can be included in the message thread 512, 612. The message thread 512, 612 can then be stored in the patient 500 and/or the care provider 600 records as messaging information 510, 610 in an embodiment.

In response to transmitting the notification to the care provider's user system 202a, the MIM system 300 can be configured, in an embodiment, to receive an indication from the care provider's user system 202a that includes the information identifying the progress note 312, and a response to the comment. In an embodiment, the response can be extracted from the indication and copied and stored in the message thread 512, 612 corresponding to the originating comment. In an embodiment, a notification including the information identifying the selected progress note 312 and/or the response can be generated and provided to the patient 203 or to the trusted contact 213b. For example, when the MIM system 300 in the client system 201 receives the indication, the notification can be generated and provided to the display handler 732 for presentation to the patient 203. In another embodiment, when the MIM system 300 in the MIMI server 204 receives the indication, the notification can be transmitted to the user system 202b of the trusted contact 213b, where the response can be extracted from the notification and presented to the trusted contact 213b.

In an embodiment, the communication page 900 illustrated in FIG. 9A can be updated to indicate that a new response has been received by changing the number of responses and/or follow up comments/questions 904. When the row 902 corresponding to the originating comment is selected, the response can be displayed to the patient 203. For example, when the row 902 is selected, the MIM system 300 can be configured to retrieve the message thread 516 corresponding to the originating comment and to include the thread 516 in a page 950 such as that shown in FIG. 9C. According to an embodiment, the page 950 can present each of the patient's comments/questions 954 in a given sequence as well as transmitted responses 952 by the care provider 213a. When the care provider 213a has responded to a question in person, an indication 952a that the care provider 213a has responded in person can also be presented. In this case, e.g., when the care provider 213a has answered a question in person, the patient 203 can submit a note 952b indicating his or her understanding of the care provider's response. In an embodiment, a draft comment 954a that has not yet been posted to the care provider 213a can also be presented in the page 950.

According to an embodiment, a follow up comment/question 954a may be linked to a different progress note or to a different problem in the plan of the progress note 312. In this case, an “Add a Progress Note” button 956 can be selected, and a drop down menu 960 listing the information identifying the first plurality of progress notes can be displayed as shown in FIG. 9D. When a progress note is selected, the progress note 312 can be displayed as shown in FIG. 9E, and the follow up comment/question 954a can be associated with the progress note 312 in general, or with a problem in the plan list.

Referring again to FIG. 8, when the calendar window 802 is selected, a calendar page 1200 such as that shown in FIG. 12 can be provided by the user interface 712. According to an embodiment, the calendar page 1200 can present information relating to a day and time and can include an events section 1202, a medication section 1204, a journal section 1206, and a detailed journal section 1208. The events section 1202 can display an event and its scheduled time block, and the medication section 1204 can display when and which medication to administer to the patient 203. In an embodiment, the journal section 1206 can display when a journal entry 1205 by the patient 203,203a is submitted, e.g., by an icon displayed in a corresponding time row. When the journal entry 1205 is selected, the contents associated with the selected entry can be provided in the detailed journal section 1208. In an embodiment, the detailed journal section 1208 can provide the journal title, its entry date and time, and the number of follow up comments 1210 associated with the entry 1205. When the number of follow up comments 1210 is selected, the follow up comments can be displayed in an embodiment.

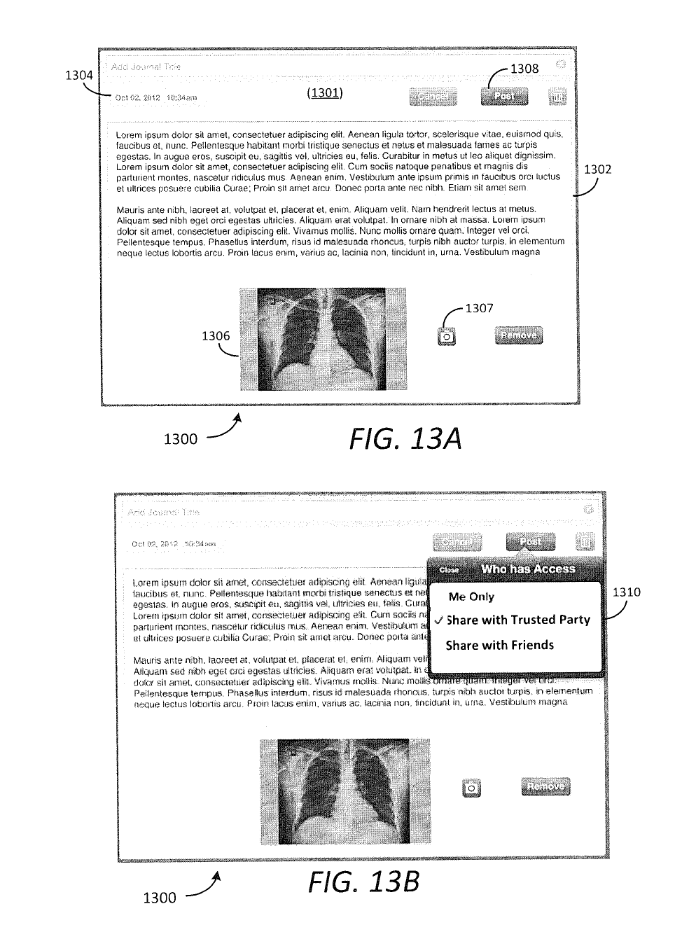

According to an embodiment, the patient 203,203a can compose a new journal entry that is linked to the current date and time by selecting a “new entry” icon 1207 in the journal section 1206. When the icon 1207 is selected, a composition page 1300 such as that shown in FIG. 13A can be provided by the user interface 712. In an embodiment, the composition page 1300 can include a date and time 1304 associated with the journal entry 1301 and a composition section 1302 where the patient 203 can write the content of the journal entry 1301. In addition, the patient 203,203a can attach an image 1306 to the journal entry 1301, in an embodiment, by selecting an image from a plurality of images 530 stored in the patient record 500 and/or from a plurality of images 724 stored in a data store 720 of the client system 201 or the user system 202. For example, when an image icon 1307 in the composition page 1300 is selected, thumbnails of the stored images 530, 724 can be displayed to the patient 203,203a, and the patient 203,203a can select at least one of the images 530, 724 to include in the journal entry 1301. Alternatively or in addition, the attached image 1306 can be an image captured on-the-fly by the client system 201 or the user system 202.

In an embodiment, when the patient 203,203a has completed the journal entry 1301, a “post” button 1308 can be selected, and the patient 203,203a can provide information identifying a recipient of the journal entry 1301. For example, when the “post” button 1308 is selected, a popup recipient window 1310 can be presented in the composition page 1300 as shown in FIG. 13B. In an embodiment, the recipient window 1310 can include information identifying the access statuses 524a, 524b of the contacts 213b, 213c on the patient's contact list 520. In another embodiment, the recipient window 1310 can also include information identifying the contacts 213b, 213c on the contact list 520 (not shown) and/or information identifying at least some of the plurality of care providers 213a. The recipient(s) of the journal entry 1301 can be identified by selecting the appropriate information. For example, in FIG. 13B, when the “trusted party” access status 524a is selected, a contact 213b having the trusted party access status 524a will be a recipient of the journal entry 1301 and another contact 213c having another access status 524b will not be a recipient.

According to an embodiment, when the patient 203,203a has completed the journal entry 1301 and has selected the information identifying at least one recipient of the journal entry 1301, the user input handler 734 can be configured to include the journal entry 1301 and the information identifying a recipient in an indication. In an embodiment, when an image is included in the journal entry 1301, the indication can also include information identifying an image 530 stored in the patient record 500, an image file 724 stored in the client 201 or user 202 system, and/or an image file created on-the-fly by the client 201 or user 202 system. In the client system 201, the indication can be routed directly to the MIM system 300, while in the user system 202, the indication can be included in a message that can be transmitted to the MIM system 300 in the MIM server 204 via the network 230.

In an embodiment, the MIM system 300 can be configured to receive the indication and to extract the information identifying the recipient(s) of the journal entry 1301. Based on that information, a recipient contact, e.g., 213b, of the plurality of contacts 213b, 213c and/or a care provider of the plurality of care providers associated with the patient 203 can be selected. For example, when the information identifying a recipient comprises the first access status 524a and the second access status 524b, any contact associated with the first 524a or the second 524b access status is selected as a recipient contact of the journal entry 1301.

According to an embodiment, when the journal recipients, e.g., contacts 213b, 213c and/or the care providers 213a, are selected, a notification including the journal entry 1301 can be generated. When the journal entry 1301 includes an image 530 stored in the patient record 500, the information identifying the included image 530 can be used to retrieve the image 530 from the patient record 500 and the retrieved image 530 can be included in the notification. Alternatively, or in addition, the notification can include the image file 724 stored in and/or created on-the-fly by the client 201 or user 202 system.

Once the notification is generated, the MIM system 300 can be configured to transmit the notification including the journal entry 1301 and optionally the image(s) 530, 724 to the user system(s) 202a-202c associated with the journal recipients 213a-213c. According to an embodiment, the notification(s) can be pushed to the user system(s) 202a-202c so that the journal recipient(s) 213a-213c receive the notification(s) immediately. Alternatively or in addition, the notification can be pulled from the MIM system 300 in the MIM client system 201 or the MIM server 204 in response to a request for notifications from a journal recipient.

In an embodiment, when the user system of a journal recipient, e.g., the trusted family member's user system 202b, receives the notification and presents the journal entry 1301 to the recipient contact 231b, the recipient contact can compose a reply to the journal entry 1301 and transmit an indication including the reply from the user system 202b to the MIM system 300 in the MIM client system 201 or the MIM server 204. When the indication is received, the MIM system 300 can be configured to generate a comment thread 514 that includes the journal entry and the recipient contact's reply, and to store the comment thread 514 in the patient's patient record 500. According to an embodiment, when the notification including the journal entry 1301 is transmitted to the user system of a second journal recipient, e.g., the casual friend contact's user system 202c, the MIM system 300 can be configured to receive a second notification that includes a second reply from the user system 202c of the second journal recipient 213c, and can be configured to update the comment thread 514 by adding the second reply, and to store the updated comment thread 514 in the patient record 500.

According to an embodiment, when the comment thread 514 is generated and/or when it is updated, the MIM system 300 can be configured to include the comment thread 514 in a notification and to provide the comment thread 514 to the patient 203, 203a, and optionally to the journal recipient(s). Alternatively, in an embodiment, the notification can be provided to the patient 203, 203a and optionally to the journal recipients at fixed time intervals, e.g., every 10 minutes, and only when the comment thread 514 has been updated.

According to an embodiment, each journal entry 1301 and its associated comment thread 514 can capture a moment of the patient's hospital experience, and collectively, the patient's journal entries 1301 can form a comprehensive diary of the patient's stay. In an embodiment, the MIM system 300 can receive a request from the patient, e.g., 203a, to download at least one of the comment threads 514 to a location designated by the patient 203a. For example, the location can be associated with the patient's user system 202, an online storage service, a removable storage drive, or another's user system, e.g., the trusted contact's user system 202b. In response to receiving the request, the MIM system 300 can retrieve the requested comment thread(s) 514 from the patient's patient record 500, and include it in a notification that is then transmitted to the designated location. According to an embodiment, when the notification is received, the requested comment thread(s) 514 can be stored so that when the patient's stay is completed, the patient 203a can keep the comment thread(s) 514 as a momento.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer implemented method for facilitating communication between a patient and a medical care provider, the method comprising:
providing, by a computer device, a medical information repository for storing a plurality of patient records and a plurality of care provider records, wherein each patient record includes information identifying a patient, information identifying at least one care provider of the patient, and messaging information of the patient, and wherein each care provider record includes information identifying a care provider, information identifying the care provider's patients, information identifying a plurality of progress notes generated by the care provider for communicating findings, opinions and plans between the care provider and other care providers, and messaging information of the care provider, wherein each of the plurality of progress notes is a medical record stored in an electronic medical record system separate and apart from the medical information repository and includes at least one of a first section for subjective information relating to a patient's medical condition, a second section for objective information relating to the patient's medical condition, a third section for assessment information assessing the patient's medical condition, and a fourth section for a treatment plan relating to the patient's medical condition;
providing, by the computer device to a first user, information identifying a first plurality of progress notes of the plurality of progress notes generated by a first care provider of a first patient, wherein the first plurality of progress notes relates to the first patient;
receiving, by the computer device, an indication from the first user including information identifying a selected progress note of the first plurality of progress notes, a first comment associated with the selected progress note, and a request to post the first comment to the first care provider; and
transmitting, by the computer device, a notification to a user system associated with the first care provider, the notification including the information identifying the selected progress note and the first comment.

2. The method of claim 1 further comprising:
storing the first comment and the information identifying the selected progress note in at least one of the patient record associated with the first patient, and the care provider record associated with the first care provider;
receiving an indication from the second user system, the indication including the information identifying the selected progress note, and a first response to the first comment;
providing a notification to the first user including the first response and at least one of the first comment and the information identifying the selected progress note; and
storing the first response in at least one of the patient record associated with the first patient, and the care provider record associated with the first care provider.

3. The method of claim 1 wherein the first user is one of the first patient and a trusted party who is permitted to access the first patient's medical information.

4. The method of claim 1 wherein in response to receiving the indication from the first user, the method further includes:
determining whether the first user is permitted to post the first comment to the first care provider based on at least one of the patient record associated with the first patient and the care provider record associated with the first care provider;
generating the notification to the second user system when the first user is permitted to post the first comment to the first care provider; and
providing a response to the first user including an error message when the first user is not permitted to post the first comment to the first care provider.

5. The method of claim 4 wherein the first comment is one of a number of comments received from the first user and associated with at least one of the first plurality of progress notes, and wherein the first user is permitted to post the first comment to the first care provider when at least one of the first care provider accepts an invitation to communicate with the first user and the number of comments received from the first user is at most equal to a threshold value.

6. The method of claim 5 wherein the threshold value is set by the first care provider and corresponds to a maximum number of comments the first user is permitted to submit to the first care provider in a predetermined time period.

7. The method of claim 1 wherein a progress note of the plurality of progress notes generated by a care provider includes a medical term and wherein the method further comprises embedding, in the progress note, a link for the medical term, wherein the link is associated with a definition of the medical term.

8. The method of claim 7 wherein the embedded link is a hyperlink associated with a web search engine, which when activated, transmits a search request to the web search engine for information relating to the medical term.

9. The method of claim 1 wherein each patient record further includes a contacts list comprising a plurality of contacts associated with the patient, the method further comprising:
receiving a first indication from the first user including information relating to a first contact and a first access status of the first contact;
receiving a second indication from the first user including information relating to a second contact and a second access status of the second contact;
adding the first contact and the second contact to the contacts list in the patient record associated with the first patient; and
providing, based on the first access status, the information identifying the first plurality of progress notes relating to the first patient to the first contact,
wherein the information identifying the first plurality of progress notes is not provided to the second contact based on the second access status.

10. The method of claim 9 wherein the first access status identifies the first contact as a trusted party and the second access status identifies the second contact as a friend.

11. The method of claim 1 wherein each patient record further includes a contacts list comprising a plurality of contacts associated with the patient, the method comprising:
receiving a first indication from the first user comprising a journal entry and information identifying a recipient of the journal entry;
selecting at least one of a recipient contact of the plurality of contacts associated with the first patient and a care provider of the plurality of care providers based on the information identifying the recipient; and
transmitting a notification to a user system of at least one of the recipient contact and the care provider, the notification including the journal entry.

12. The method of claim 11 wherein each of the plurality of contacts is associated with one of a first and a second access status and wherein the information identifying the recipient comprises at least one of the first access status and the second access status.

13. The method of claim 11 further including:
receiving an indication from the user system associated with at least one of the recipient contact and the care provider, wherein the indication includes a reply to the journal entry;
in response to receiving the indication, generating a comment thread comprising the journal entry and the reply in the indication; and
storing the comment thread in the first patient's patient record.

14. The method of claim 13 further comprising providing a notification to the first user, the notification including the comment thread.

15. The method of claim 13 further comprising:
receiving a request from the first user to download the comment thread to a location designated by the first user;
retrieving the comment thread from the first patient's patient record; and
transmitting the comment thread to the location designated by the first user.

16. The method of claim 1 wherein each patient record further includes a contacts list comprising a plurality of contacts associated with the patient and a plurality of images associated with the patient, and wherein the method further comprising:
receiving a first indication from the first user comprising a journal entry, information identifying a recipient of the journal entry, and at least one of information identifying a first image of the plurality of images associated with the first patient and a second image file created on-the-fly by a user system associated with the first user;
selecting at least one of a recipient contact of the plurality of contacts associated with the first patient and a care provider of the plurality of care providers based on the information identifying the recipient; and
transmitting a notification to a user system of at least one of the recipient contact and the care provider, the notification including the journal entry and at least one of the first image and the second image.

17. A computer implemented method for providing medical information to a patient, the method comprising:
providing, by a computer device, a medical information repository for storing a plurality of patient records and a plurality of care provider records, wherein each patient record includes information identifying a patient, information identifying at least one care provider of the patient, and messaging information of the patient, and wherein each care provider record includes information identifying a care provider, information identifying the care provider's patients, and information identifying a plurality of progress notes generated by the care provider for communicating findings, opinions and plans between the care provider and other care providers, wherein each of the plurality of progress notes is a medical record stored in an electronic medical record system separate and apart from the medical information repository and includes at least one of a first section for subjective information relating to a patient's medical condition, a second section for objective information relating to the patient's medical condition, a third section for assessment information assessing the patient's medical condition, and a fourth section for a treatment plan relating to the patient's medical condition, and wherein at least one of the plurality of progress notes includes a medical term;
embedding, by the computer device and in the at least one progress note, a link for the medical term, wherein the link is associated with a definition of the medical term;
providing, by the computer device to a first user, information identifying a first plurality of progress notes of the plurality of progress notes generated by a first care provider of a first patient, wherein the first plurality of progress notes relates to the first patient and includes a progress note having an embedded link associated with a definition of a medical term;
receiving, by the computer device, an indication from the first user including the embedded link and a request for the information relating to the medical term;
activating, by the computer device, the embedded link to retrieve the information relating to the medical term associated with the embedded link; and
providing, by the computer device, a notification to the first user including the retrieved information relating to the medical term.

18. A computer implemented method for sharing medical information of a patient with a trusted party, the method comprising:
providing, by the computer device, a medical information repository for storing a plurality of patient records and a plurality of care provider records, wherein each patient record includes information identifying a patient, information identifying at least one care provider of the patient, messaging information of the patient, and a contacts list comprising a plurality of contacts associated with the patient, wherein each of the plurality of contacts is associated with an access status, and wherein each care provider record includes information identifying a care provider, information identifying the care provider's patients, information identifying a plurality of progress notes generated by the care provider for communicating findings, opinions and plans between the care provider and other care providers, and messaging information of the care provider, wherein each of the plurality of progress notes is a medical record stored in an electronic medical record system separate and apart from the medical information repository and includes at least one of a first section for subjective information relating to a patient's medical condition, a second section for objective information relating to the patient's medical condition, a third section for assessment information assessing the patient's medical condition, and a fourth section for a treatment plan relating to the patient's medical condition;
identifying, by the computer device, a first contact and a second contact from a first contacts list of a first patient, the first contact having a first access status and the second contact having a second access status, wherein the first access status identifies the first contact as a trusted party and the second access status identifies the second contact as a friend; and
transmitting, by the computer device and based on the first access status, information identifying a first plurality of progress notes of the plurality of progress notes generated by a first care provider of the first patient to a first user system associated with the first contact, wherein the first plurality of progress notes comprises medical information relating to the first patient, and wherein the information identifying the first plurality of progress notes is not transmitted to a user system associated with the second contact based on the second access status.

19. A non-transitory computer-readable medium carrying one or more sequences of instructions for facilitating communication between a patient and a medical care provider, which instructions, when executed by one or more processors, cause the one or more processors to perform operations comprising:
providing a medical information repository for storing a plurality of patient records and a plurality of care provider records, wherein each patient record includes information identifying a patient, information identifying at least one care provider of the patient, and messaging information of the patient, and wherein each care provider record includes information identifying a care provider, information identifying the care provider's patients, information identifying a plurality of progress notes generated by the care provider for communicating findings, opinions and plans between the care provider and other care providers, and messaging information of the care provider, wherein each of the plurality of progress notes is a medical record stored in an electronic medical record system separate and apart from the medical information repository and includes at least one of a first section for subjective information relating to a patient's medical condition, a second section for objective information relating to the patient's medical condition, a third section for assessment information assessing the patient's medical condition, and a fourth section for a treatment plan relating to the patient's medical condition;
providing, to a first user, information identifying a first plurality of progress notes of the plurality of progress notes generated by a first care provider of a first patient, wherein the first plurality of progress notes relates to the first patient;
receiving an indication from the first user including information identifying a selected progress note of the first plurality of progress notes, a first comment associated with the selected progress note, and a request to post the first comment to the first care provider; and
transmitting a notification to a user system associated with the first care provider, the notification including the information identifying the selected progress note and the first comment.

20. The computer-readable medium of claim 19 wherein at least one of the plurality of progress notes includes a medical term, and wherein the one or more sequences of instructions cause the one or more processors to perform further operations comprising:
embedding, in the at least one progress note, a link for the medical term, wherein the link is associated with a definition of the medical term;
providing, to the first user, information identifying a second plurality of progress notes of the plurality of progress notes generated by the first care provider of the first patient, wherein the second plurality of progress notes relates to the first patient and includes a progress note having an embedded link associated with a definition of a medical term;
receiving an indication from the first user including the embedded link and a request for the information relating to the medical term;
activating the embedded link to retrieve the information relating to the medical term associated with the embedded link; and
providing a notification to the first user including the retrieved information relating to the medical term.
